(19) United States
(12) Patent Application Publication
(10) Pub. No.: US 2018/0197563 A1
(43) Pub. Date: Jul. 12, 2018

(54) AUDIO SIGNAL PROCESSING CIRCUIT, IN-VEHICLE AUDIO SYSTEM, AUDIO COMPONENT DEVICE AND ELECTRONIC APPARATUS INCLUDING THE SAME, AND METHOD OF PROCESSING AUDIO SIGNAL

(71) Applicant: ROHM CO., LTD., Ukyo-ku (JP)

(72) Inventor: Mitsuteru SAKAI, Ukyo-ku Kyoto (JP)

(21) Appl. No.: 15/861,322

(22) Filed: Jan. 3, 2018

(30) Foreign Application Priority Data
Jan. 6, 2017 (JP) 2017-000945

(51) Int. Cl. G10L 21/0388; G10L 19/025; G10L 19/008

(52) U.S. Cl. CPC G10L 21/0388; G10L 19/008; G10L 19/025

(57) ABSTRACT

An audio signal processing circuit includes: a frequency band divider configured to divide an input audio signal having an input sampling frequency into a first signal down-sampled to an internal sampling frequency including a first frequency band lower than the input sampling frequency, and a second signal including a second frequency band higher than the first frequency band; and a main digital signal processor configured to perform digital signal processing on the first signal.

### CROSS-REFERENCE TO RELATED APPLICATION

The present application claims priority under 35 U.S.C. § 119 to Japanese Patent Application No. 2017-000945, filed on Jan. 6, 2017, the entire contents of which are incorporated herein by reference.

### TECHNICAL FIELD

The present disclosure relates to an audio signal processing circuit.

### BACKGROUND

In recent years, high-resolution sound sources have been increasingly popular and high-resolution correspondence is also required for audio playback apparatuses. Although the definition of high-resolution is varied, the present disclosure deals with an apparatus capable of processing a digital signal of 24 bits and 96 kHz or more and outputting an analog signal with a frequency (for example, 40 kHz or more) higher than an audible frequency band, as a high-resolution correspondence apparatus. In the present disclosure, other than high-resolution is also referred to as non-high-resolution or low-resolution.

FIGS. 1A and 1B are block diagrams of audio systems capable of reproducing a low-resolution sound source and a high-resolution sound source, respectively, which are examined by the present inventors. The audio system 200L in FIG. 1A reproduces low-resolution audio data (also referred to as audio signal) S_{LR}. The audio system 200L includes a digital signal processor 210L, a D/A converter 220, a power amplifier 230 and a speaker 240.

The digital signal processor 210L performs various digital signal processing operations on the audio data S_{LR}. The digital signal processor 210L includes a digital volume circuit 212L and a digital filter circuit 214L.

The D/A converter 220 converts the audio signal processed by the digital signal processor 210L into an analog audio signal S_{ANALOG}. The power amplifier 230 amplifies the audio signal S_{ANALOG} and drives the speaker 240.

A sampling frequency higher than twice the highest frequency included in the audio data. S_{LR} is required for the digital signal processor 2101. Since the low-resolution audio data S_{LR} includes an audible frequency hand of 20 to 20 kHz, 40 kHz will suffice as the sampling frequency fs of the digital signal processor 210L.

The audio system 200H of FIG. 1B reproduces high-resolution audio data S_{HR}. The audio system 200H has the same configuration as the audio system 200L of FIG. 1A.

The high-resolution audio data S_{HR} includes frequency components higher than the audible frequency hand of 20 to 20 kHz. For example, when a frequency component of up to 40 kHz is included in the audio data S_{HR}, the sampling frequency fs higher than 80 kHz is required for the digital signal processor 210H. When a frequency component of up to 96 kHz is included in the audio data S_{HR}, the sampling frequency fs higher than 192 kHz is required for the digital signal processor 210H.

Since the operation clock of the digital signal processor 210H increases according to the sampling frequency fs, the circuit scale (area) of the high-resolution digital signal processor 210H is larger than the circuit scale of the non-high-resolution digital signal processor 210L, which will lead to an increase in production costs. The circuit scale increases with the increase in sampling frequency of the high-resolution sound source.

In addition, since the frequency of the operation clock of the high-resolution digital signal processor 210H increases, its power consumption also becomes larger than the power consumption of the non-high resolution digital signal processor 210L.

Under these circumstances, the audio system 200H corresponding to the high-resolution sound source becomes more expensive than the non-high resolution audio system 200L, which hinders further spread of high-resolution sound sources.

### SUMMARY

Some embodiments of the present disclosure provide an audio system capable of reproducing a high-resolution sound source with reduced costs and/or low power consumption.

According to an embodiment of the present disclosure, an audio signal processing circuit is provided. The audio signal processing circuit includes: a frequency band divider configured to divide an input audio signal having an input sampling frequency into a first signal down-sampled to an internal sampling frequency including a first frequency band lower than the input sampling frequency, and a second signal including a second frequency band higher than the first frequency band; and a main digital signal processor configured to perform digital signal processing on the first signal.

According to the embodiment, the main digital signal processor does not necessarily process the entire frequency band, and the sampling frequency to be dealt with by the main digital signal processor may be about twice the highest frequency included in the first signal. Therefore, the size of the main digital signal processor may be reduced, lowering cost and/or reducing power consumption.

The input sampling frequency may be 96 kHz or 192 kHz, and the internal sampling frequency may be 48 kHz.

The frequency band divider may include a down-sampling circuit that down-samples the input audio signal to the internal sampling frequency. An output of the down-sampling circuit may be the first signal

The internal sampling frequency may be set around twice the highest frequency of the audible frequency band. Thus, the audible frequency band may be extracted as the first signal.

The frequency band divider may further include a filter disposed at the subsequent stage of the down-sampling circuit and an output of the filter may be the first signal. The first frequency band may be defined according to a cutoff frequency of the filter.

The frequency band divider may further include: a first up-sampling circuit that up-samples the output of the down-sampling circuit to the input sampling frequency; and a subtractor that generates a difference between the input audio signal and an output of the first up-sampling circuit, and an output of the subtractor may be the second signal. Since the audible frequency band is included in the output of the first up-sampling circuit, the difference between the input audio signal and the output of the first up-sampling circuit, in other words, the second signal may be obtained to have a frequency band higher than the audible frequency band. The second signal thus obtained is not affected by cut-off characteristics (crossover characteristics) of the filter, as compared with a case where a frequency band higher than the audible frequency band is obtained using a high-pass filter.

The frequency band divider may further include a high-pass filter that passes a high frequency component of the input audio signal, and an output of the high-pass filter may be the second signal. The second frequency band may be defined according to a cut-off frequency of the high-pass filter.

The audio signal processing circuit may further include a sub-digital signal processor configured to perform digital signal processing on the second signal, wherein the sub-digital signal processor performs digital processing using fewer steps compared to the main digital signal processor.

The frequency band divider may further include a sub-band divider configured to divide the first signal into a plurality of sub-frequency bands, wherein the main digital signal processor may execute digital signal processing for each of the sub-frequency bands.

The second signal may include a portion of an audible frequency band.

The first signal and the second signal may be individually output. Thus, the first frequency band and the second frequency band may be reproduced from separate speaker units respectively.

The audible frequency band may not be included in the second signal, and the audio signal processing circuit may output a signal obtained by combining the first signal and the second signal.

The audio signal processing circuit may further include a second up-sampling circuit configured to up-sample an output of the main digital signal processor to the input sampling frequency; and an adder configured to combine the second signal and an output of the second up-sampling circuit.

The audio signal processing circuit may be integrally integrated on a single semiconductor substrate. The expression “integrally integrated” includes a case where all constituent elements of a circuit are formed on the semiconductor substrate, a case where main constituent elements of the circuit are integrally integrated, and a case where some resistors, capacitors and the like may be provided outside the semiconductor substrate.

According to another embodiment of the present disclosure, an in-vehicle audio system is provided. The in-vehicle audio system may include one of the aforementioned audio signal processing circuits.

According to another embodiment of the present disclosure, an audio component device is provided. The audio component device may include one of the aforementioned audio signal processing circuits

According to another embodiment of the present disclosure, an electronic apparatus is provided. The electronic apparatus may include one of the aforementioned audio signal processing circuits.

Any combination of the above constituent elements, and constituent elements and expressions of the present disclosure are mutually substituted among methods, apparatuses, systems, etc. are also effective as embodiments of the present disclosure.

Further, the description in this part does not explain all the essential features of the present disclosure, so that sub-combinations of the features which are described may also be included in the present disclosure.

### BRIEF DESCRIPTION OF DRAWINGS

FIGS. 1A and 1B are block diagrams of audio systems capable of reproducing a low-resolution sound source and a high-resolution sound source, respectively, which are examined by the present inventors.

FIG. 2 is a block diagram showing the basic configuration of an audio signal processing circuit according to an embodiment of the present disclosure.

FIGS. 3A and 3B are views for explaining processing of the audio signal processing circuit of FIG. 2.

FIG. 4 is a block diagram of an audio system including an audio signal processing circuit according to a first embodiment of the present disclosure.

FIG. 5 is a block diagram of an audio system including an audio signal processing circuit according to a second embodiment of the present disclosure.

FIG. 6 is a block diagram of an audio system including an audio signal processing circuit according to a third embodiment of the present disclosure.

FIG. 7 is a block diagram of an audio system including an audio signal processing circuit according to a fourth embodiment of the present disclosure.

FIG. 8 is a block diagram of an audio system according to a fifth embodiment of the present disclosure.

FIG. 9 is a block diagram of an in-vehicle audio system including an audio signal processing circuit.

FIG. 10 is a block diagram of another in-vehicle audio system including an audio signal processing circuit.

FIGS. 11A and 11B are views showing electronic apparatuses, each of which includes an audio signal processing circuit, and FIG. 11C is a view showing an audio component device.

### DETAILED DESCRIPTION

Embodiments of the present disclosure will be now described in detail with reference to the drawings. Like or equivalent components, members, and processes illustrated in each drawing are given like reference numerals and a repeated description thereof will be properly omitted. Further, the embodiments are presented by way of example only, and are not intended to limit the present disclosure, and any feature or combination thereof described in the embodiments may not necessarily be essential to the present disclosure.

In the present disclosure, “a state where a member A is connected to a member B” includes a case where the member A and the member B are physically directly connected or even a case where the member A and the member B are indirectly connected through any other member that does not affect an electrical connection state between the members A and B or does not impair functions achieved by combinations of the members A and B.

Similarly, “a state where a member C is installed between a member A and a member B” includes a case where the member A and the member C or the member B and the member C are indirectly connected through any other member that does not affect an electrical connection state between the members A and C or the members B and C or does not impair function achieved by combinations of the members A and C or the members B and C, in addition to a case where the member A and the member C or the member B and the member C are directly connected.

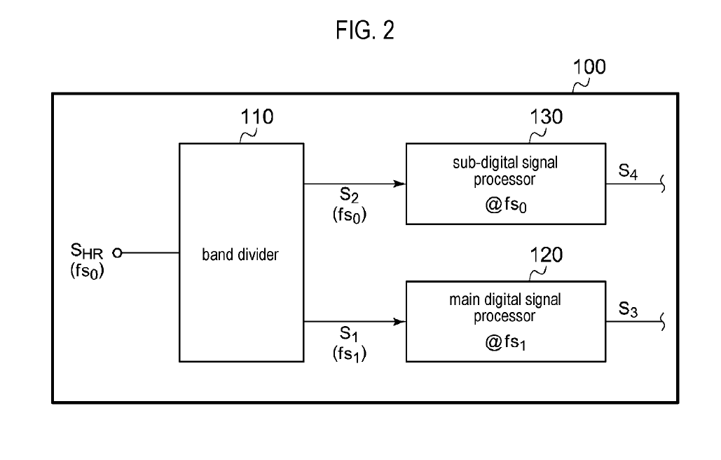

FIG. 2 is a block diagram showing a basic configuration of an audio signal processing circuit 100 according to an embodiment of the present disclosure. In FIG. 2, only main parts of the audio signal processing circuit 100 are illustrated and other blocks are omitted.

The audio signal processing circuit 100 is provided to process a high-resolution input audio signal S_{HR}, and includes a frequency band divider 110, a main digital signal processor 120 and a sub-digital signal processor 130.

The frequency band divider 110 receives the input audio signal S_{HR} having an input sampling frequency fs₀ and generates a first signal S₁ including a first frequency band FB₁ and a second signal S₂ including a second frequency band FB₂ higher than the first frequency band FB₁. The first signal S₁ is down-sampled to an internal sampling frequency fs₁ lower than the input sampling frequency fs₀.

The first signal S₁ includes the entire audible frequency band (alternatively, a part of the audible frequency band on its love frequency side) of the input audio signal S_{HR,} and the second signal S₂ includes the rest of input audio signal S_{HR,}, in other words, the frequency band other than the entire the audible frequency band (alternatively, the frequency band other than the part of the audible frequency band on its low frequency side) of the input audio signal S_{HR}. A sampling frequency fs₂ of the second signal S₂ is equal to the input sampling frequency fs₀ of the original input audio signal S_{HR}.

The main digital signal processor 120 processes the down-sampled first signal S₁ at the internal sampling frequency fs₁. Contents of digital signal processing include but are not particularly limited to, for example, multiband equalizing processing, multiband tone control processing, digital volume processing, loudness processing, bus boost processing and the like.

The sub-digital signal processor 130 performs digital signal processing on the second signal S₂. For example, in some embodiments, the sub-digital signal processor 130 may be provided when the audible frequency band is included in the second signal S₂. Since the second signal S₂ is mainly out of the audible frequency band, the signal processing in the sub-digital signal processor 130 can be simplified more than the main digital signal processor 120. For example, the sub-digital signal processor 130 does not need a bus boost function or the like. When the main digital signal processor 120 and the sub-digital signal processor 130 include a multiband equalizer, the number of bands of the sub-digital signal processor 130 is smaller than the number of bands of the main digital signal processor 120, so that the former is made simpler than the latter. Note that the sub-digital signal processor 130 is optional and may be omitted in some cases.

An output signal S₃ of the main digital signal processor 120 and an output signal S₄ of the sub-digital signal processor 130 are supplied to a circuit block (not shown). As will be described later, the processes performed by the main digital signal processor 120 and the sub-digital signal processor 130 are various and are not particularly limited.

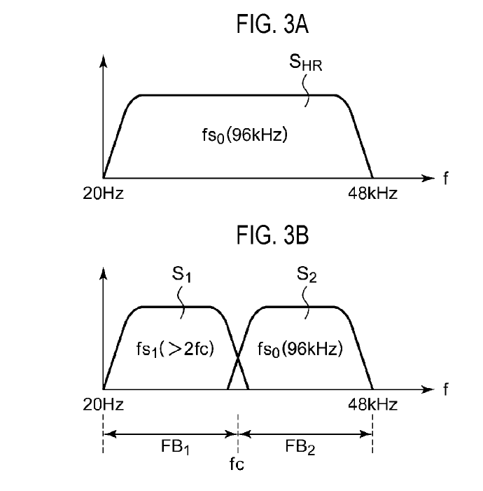

The above is the basic configuration of the audio signal processing circuit 100. Subsequently, the operation thereof will be explained. FIGS. 3A and 3B are views for explaining the processing of the audio signal processing circuit 100 of FIG. 2. FIG. 3A shows the spectrum of the original input audio signal S_{HR} and FIG. 3B shows the spectrums of the first signal S₁ and the second signal S₂.

For example, when fₛ₀=96 kHz, the input audio signal S_{HR} includes a frequency component of up to 48 kHz.

Assuming that the crossover frequency between the first frequency band FB₁ and the second frequency band FB₂ is f_{c}, the highest frequency of the first frequency band FB₁ may be considered to be substantially equal to the crossover frequency f_{c}.

The sampling frequency fs₁ of the first signal S₁ may satisfy the condition of fs₁>2f_{c}. When the crossover frequency f_{c} is 20 kHz, it is sufficient for the internal sampling frequency fs₁ to be higher than 40 kHz. For example, fs1 may be 48 kHz, which is lower than the original input sampling frequency fs₀ (=96 kHz).

The main digital signal processor 120 processes the first signal S₁ at the internal sampling frequency fs₁, and the sub-digital signal processor 130 processes the second signal S₂ at the input sampling frequency fs₀.

The above is the operation of the audio signal processing circuit 100.

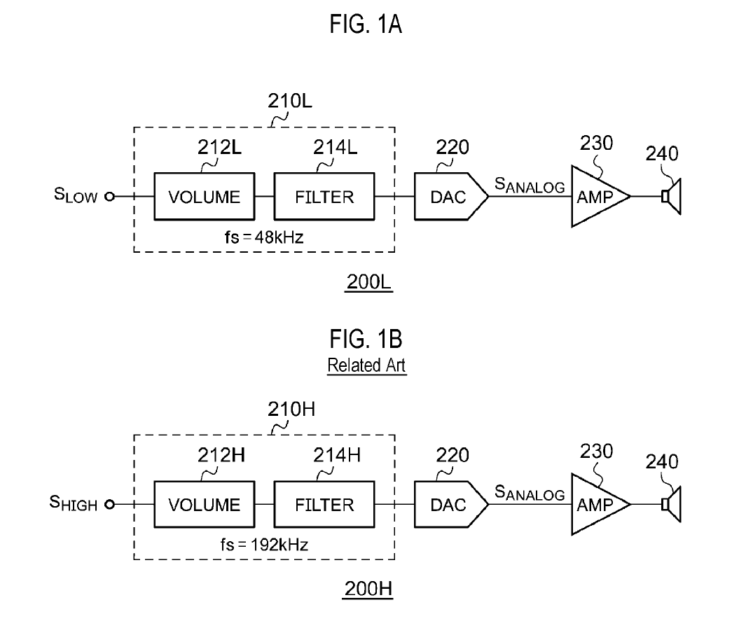

The advantages of the audio signal processing circuit 100 are clarified by comparison with the audio system 200H of FIG. 1B. In the audio system 200H, the digital signal processor 210H needs to process the entire frequency band of the input audio signal S_{HR} and, when fs₀=96 kHz, the sampling frequency of the digital signal processor 210H is also 96 kHz.

On the other hand, in the audio signal processing circuit 100 of FIG. 2, the main digital signal processor 120 does not need to process the entire frequency band of the input audio signal S_{HR} and the sampling frequency fs₁ required for this processor 120 may be, for example, 48 kHz, which is about twice the highest frequency included in the first signal S₁.

A case is considered where the same processing as that performed by the digital signal processor 210H of FIG. 1B is performed by a combination of the main digital signal processor 120 and the sub-digital signal processor 130. The area of the digital signal processing circuit is scaled according to the sampling frequency. As an example, the circuit area of the main digital signal processor 120 can be reduced to ½ of the digital signal processor 210H.

On the other hand, a total area of the sub-digital signal processor 130 and the frequency band divider 110, which are additionally required, is sufficiently smaller than ½ of the area of the digital signal processor 210H. Therefore, the audio signal processing circuit 100 of FIG. 2 can be made smaller than the digital signal processor 210H, which in turn makes it possible to reduce the cost of the audio signal processing circuit 100.

In addition, since the sampling frequency of the main digital signal processor 120 can be lowered, power consumption can be reduced.

For the audio signal S_{HR} of the input sampling frequency fs₀=192 kHz, when the frequency fs₁=48 kHz, an area reduction effect becomes even more prominent.

The present disclosure is grasped as the block diagram and circuit diagram of FIG. 2 or covers various devices and circuits derived from the above description. However, the present disclosure is not limited to the disclosed particular configurations. Hereinafter, more specific examples and modifications will be described in order to aid the understanding of the nature and circuit operation of the present disclosure and clarify them without narrowing the scope of the present disclosure.

### First Embodiment

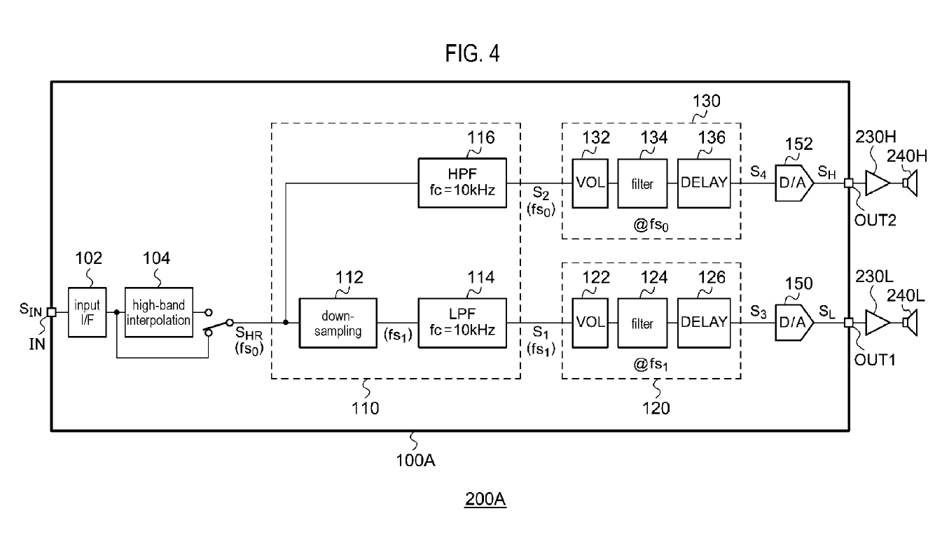

FIG. 4 is a block diagram of an audio system 200A including an audio signal processing circuit 100A according to a first embodiment. The audio system 200A is a two-way network playback system and includes an audio signal processing circuit 100A, power amplifiers 230H and 230L and speaker units 240H and the 240L. The speaker unit 240H for high hand is also referred to as a tweeter and the speaker unit 240L for low band is also referred to as a woofer.

In FIG. 4 and the following figures, only one channel is shown. In actuality, however, the same number of circuits as channels of the input audio signal S_{HR} is provided.

The audio signal processing circuit 100A individually outputs analog audio signals S_{L} and S_{H} in the reproduction frequency bands of the speaker unit 240L and the speaker unit 240H, respectively. The power amplifiers 230L and 230H amplify the analog audio signals S_{L} and S_{H}, respectively, and drive the speaker units 240L and 240H, respectively.

The configuration of the audio signal processing circuit 100A will be described. The audio signal processing circuit 100A includes an input interface 102, a high-band interpolator 104 and D/A converters 150 and 152 in addition to the above-described frequency band divider 110, main digital signal processor 120 and sub-digital signal processor 130, all of which are integrated on a single semiconductor substrate.

The input interface 102 receives high-resolution or non-high-resolution audio data S_{IN} from a sound source (not shown). The high-band interpolator 104 can be switched on and off and interpolates high-band frequency components when the audio data S_{IN} has non-high-resolution or is a compressed sound source such as MP3 or the like. The high-band interpolator 104 may be omitted.

The frequency band divider 110 includes a down-sampling circuit 112, a low-pass filter 114 and a high-pass filter 116. The down-sampling circuit 112 is a sampling rate converter and down-samples the input audio signal S_{HR} to the internal sampling frequency fs₁. The low-pass filter 114 is provided at the subsequent stage of the down-sampling circuit 112, and an output of the low-pass filter 114 becomes the first signal S₁. Although the low-pass filter 114 may be provided at the previous stage of the down-sampling circuit 112, the circuit scale of the low-pass filter 114 can be reduced by providing the low-pass filter 114 at a subsequent stage of the down-sampling circuit 112.

The high-pass filter 116 extracts a high frequency component of the input audio signal S_{HR} and generates the second signal S₂. The cutoff frequency of each of the low-pass filter 114 and the high-pass filter 116 is defined according to the crossover frequency f_{c} between the first frequency band FB₁ and the second frequency band FB₂.

In this embodiment, the crossover frequency f_{c} is defined based on the reproduction frequency band of the speaker unit 240H and is lower than the highest frequency (20 kHz) of the audible frequency band. Therefore, the second frequency band FB₂ includes a part of the higher frequency side of the audio frequency band. For example, the crossover frequency f_{c} is 10 kHz, the first frequency band FB₁ includes frequency components of 20 to 10 kHz, and the second frequency band FB₂ includes frequency components higher than 10 kHz.

The internal sampling frequency fs₁ can be set to any value as long as it is higher than 2×f_{c} (=20 kHz). The conventional non-high-resolution digital signal processor is often designed with a sampling frequency of 48 kHz. Therefore, from the viewpoint of effective utilization of circuit resources, the internal sampling frequency fs₁ of the first signal S₁ after the down-sampling is preferably 48 kHz.

The main digital signal processor 120 processes the first signal S₁ including the first frequency band FB₁ and the sub-digital signal processor 130 processes the second signal S₂ including the second frequency band FB₂. The main digital signal processor 120 includes a digital volume circuit 122, a filter block 124 and a delay block 126. Similarly, the sub-digital signal processor 130 includes a digital volume circuit 132, a filter block 134 and a delay block 136.

The digital volume circuits 122 and 132 adjust the amplitudes of the first signal S₁ and the second signal S₂, respectively, based on a volume value (volume) set by a user.

The combination of the filter block 124 and the filter block 134 executes (i) multiband equalizing processing, (ii) multiband tone control processing, (iii) loudness processing, (iv) bus boost processing, and the like.

The filter block 134 is simpler than the filter block 124. For example, since no frequency component to be subjected to the bus boost processing is included in the second signal S₂, this function is excluded from the filter block 134.

In connection with the multiband equalizing processing, since the number of bands included in the second signal S₂ is smaller than the number of bands included in the first signal S₁, this function can be simplified more in the filter block 134 than in the digital volume circuit 132. For example, for a 13-band equalizer, the filter block 124 is responsible for eleven bands on the low band side and the filter block 134 is responsible for two bands on the high band side.

In connection with multiband tone control processing, since the number of bands included in the second signal S₂ is smaller than the number of bands included in the first signal S₁, this function can be simplified more in the filter block 134 then in the digital volume circuit 132. For example, for three-band tone control of low, mid and treble, the filter block 124 is responsible for two bands of low and mid, and the filter block 134 is responsible for one band of treble.

The delay blocks 126 and 136 adjust the relative delay amounts of the analog audio signals S_{L} and S_{H}. The delay blocks 126 and 136 are responsible for a first function of aligning the delays of the first signal S₁ and the second signal S₂ and a second function of positively giving a delay difference to the audio signals S_{L} and S_{H}.

In comparison between the first signal S₁ and the second signal S₂, since the first signal S₁ passes through the down-sampling circuit 112 and the first signal S₁ and the second signal S₂ pass through different filter circuits, the first signal S₁ is delayed by Δτ compared to the second signal S₂. Therefore, the delay blocks 126 and 136 cancel this delay amount Δτ (the first function).

The second function is what is called time alignment. In an in-vehicle audio system, the speaker units 240L and 240H may be installed at separate locations. In this case, if a delay difference between the outputs S_{H} and S_{L} of the audio signal processing circuit 100A is zero, a sound reaches the ears of a listener (driver) at different timings from the speaker units 240L and 240H, which deteriorates the sound quality. The delay amount of the delay blocks 126 and 136 is set so that a distance difference between a listening position and the two speaker units 240H and 240L is canceled.

Therefore, the delay amount for time alignment is set in the delay block 126, and the delay amount for canceling the delay amount of the down-sampling circuit 112 and the delay amount for time alignment are set in the delay block 136. When the time alignment function is omitted, the delay block 126 may be omitted.

The D/A converters 150 and 152 convert the outputs S₃ and S₄ of the main digital signal processor 120 and the sub-digital signal processor 130 into analog audio signals S_{L} and S_{H}, respectively.

The above is the configuration of the audio system 200A. By using the audio signal processing circuit 100A, it is possible to provide the audio system 200A with low cost and/or low power consumption.

Moreover, in the existing case, it is possible to cope with high-resolution simply by replacing the audio signal processing circuit.

### Second Embodiment

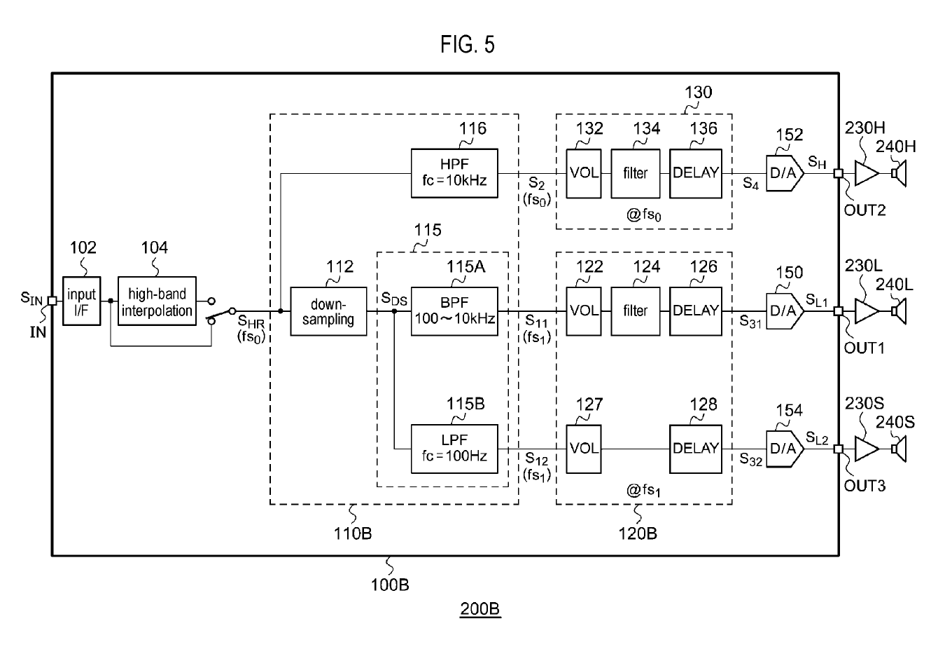

FIG. 5 is a block diagram of an audio system 200B including an audio signal processing circuit 1008 according to a second embodiment of the present disclosure. The audio system 200B is a three-way network playback system and includes an audio signal processing circuit 100B, power amplifiers 230H, 230L and 230S, and speaker units 240H, 240L and 240S.

The audio signal processing circuit 100B divides the first signal S₁ described in the first embodiment into two sub-frequency bands and outputs them. A frequency band divider 110B includes a sub-band divider 115 instead of the low-pass filter 114 in FIG. 4. The sub-band divider 115 divides the first signal S₁ into a plurality of sub-frequency bands and outputs signals S₁₁ and S₁₂ for each sub-frequency band.

As one example, one of the sub-frequency bands is a deep-bass frequency band (20 to 100 Hz) and the other is a frequency band from a low range to a middle and high range (100 Hz to 10 kHz). Such an audio system is referred to as a 2.1 channel (5.1 channel) and the like, and a 0.1 channel corresponds to a deep-bass. The speaker units 240H, 240L and 240S may be a tweeter responsible for a high band, a woofer responsible for a low band, and a sub-woofer responsible for a deep-bass, respectively.

The sub-band divider 115 includes a band-pass filter 115A and a low-pass filter 115B. The low-pass filter 115B extracts a frequency component corresponding to the speaker unit 240S. For example, when the speaker unit 240S is a sub-woofer and its reproduction frequency band is 20 to 100 Hz, a cutoff frequency f_{c} of the low-pass filter 115B is 100 Hz. The band-pass filter 115A extracts a frequency component corresponding to the speaker unit 240L. In this example, the band-pass filter 115A extracts a frequency component of 100 Hz to 100 kHz. If a band of 10 kHz or more is not included in the output S_{DS} of the down-sampling circuit 112, the band-pass filter 115A may be replaced with a high-pass filter.

The main digital signal processor 120B executes digital signal processing for each sub-frequency band. The main digital signal processor 120B includes a digital volume circuit 122 for processing the signal S₁₁ of the first sub-frequency band, a filter block 124 and a delay block 126, which are the same as those in FIG. 4.

The main digital signal processor 120B includes a digital volume circuit 127 for processing the signal S₁₂ of the second sub-frequency band (deep-bass), and a delay block 128. For the deep-bass, since an equalizing process is unnecessary, the filter block may be omitted.

Only one reproduction block (115B, 127 or 128) of the second sub-frequency band corresponding to the deep-bass is provided commonly for all channels, and reproduces a signal obtained by synthesizing the components of deep-bass of all the channels.

The D/A converters 150, 152 and 154 convert the corresponding digital signals S₃₁, S₃₂ and S₄ into analog audio signals S_{L1}, S_{L2} and S_{H}, respectively.

### Third Embodiment

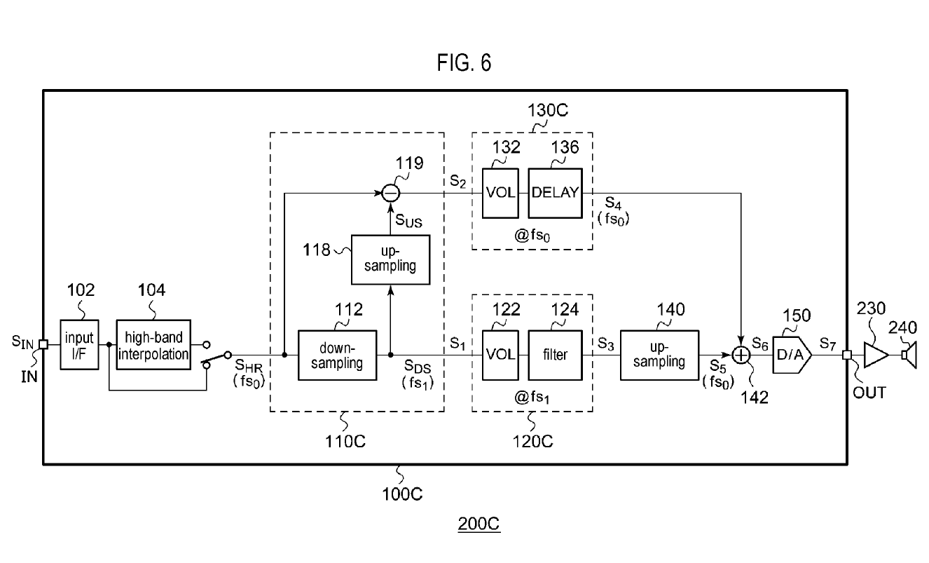

FIG. 6 is a block diagram of an audio system 200C including an audio signal processing circuit 1000 according to a third embodiment. In the first and second embodiments, the audible frequency band is included in the second signal S₂. In contrast, in the third embodiment, the second signal S₂ includes only frequency components outside the audible frequency band. Therefore, the crossover frequency f_{c} of the first frequency band FB₁ and the second frequency band FB₂ is set to be higher than 20 kHz, for example, 24 kHz.

The audio signal processing circuit 100C digitally processes the first signal S₁ and the second signal S₂, synthesizes the processed signals, converts a signal obtained by the synthesis into an analog audio signal, and outputs them. A power amplifier 230 receives the output signal of the audio signal processing circuit 100C and drives a speaker 240. The reproduction frequency band of the speaker 240 extends over the entire frequency band.

A frequency band divider 110C includes a down-sampling circuit 112, a first up-sampling circuit 118 and a subtractor 119. The down-sampling circuit 112 down-samples the input audio signal SUR to the internal sampling frequency fs₁. The output S_{DS} of the down-sampling circuit 112 includes only frequency components lower than fs₁/2 and corresponds to the first signal S₁. For example, when fs₁=48 kHz, the first signal S₁ includes an audible frequency band of 20 to 20 kHz.

The first up-sampling circuit 118 is a sampling rate converter and up-samples the output S_{DS} of the down-sampling circuit 112 again to the input sampling frequency fs₀. The subtractor 119 generates a signal corresponding to a difference between the input audio signal S_{HR} and an output S_{US} of the first up-sampling circuit 118. The output of the subtractor 119 corresponds to the second signal S₂. Since the output S_{DS} of the down-sampling circuit 112 is a signal including the audible frequency band as described above, the signal S_{US} obtained by up-sampling the output S_{DS} includes the audible frequency band. Therefore, the output of the subtractor 119 is a signal obtained by removing the audible frequency band from the input audio signal S_{HR}, and hence it is a signal outside the audible frequency band.

The main digital signal processor 120C processes the first signal S₁. The main digital signal processor 120C includes a digital volume circuit 122 and a filter block 124. In the third embodiment, since the first signal S₁ and the second signal S₂ are reproduced from the same speaker 240, the time alignment function is unnecessary. Therefore, the delay block 126 is excluded from the main digital signal processor 120C.

A sub-digital signal processor 130C includes a digital volume circuit 132 and a delay block 136. The delay block 136 matches delay amounts of the first signal S₁ and the second signal S₂.

A second up-sampling circuit 140 up-samples an output S₃ of the main digital signal processor 120C to the original input sampling frequency fs₀. An adder 142 adds an output S₅ of the second up-sampling circuit 140 and an output S₄ of the sub-digital signal processor 130C. The D/A converter 150 converts an output S₆ of the adder 142 into an analog audio signal S₇. The analog audio signal S₇ includes all the frequency bands included in the original input audio signal S_{HR}.

### Fourth Embodiment

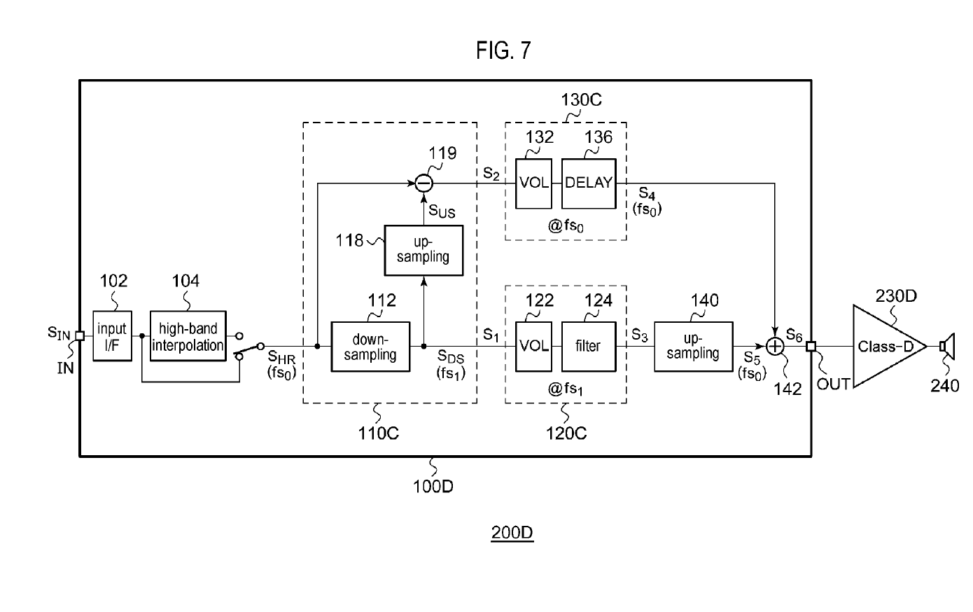

FIG. 7 is a block diagram of an audio system 200D including an audio signal processing circuit 100D according to a fourth embodiment. The audio signal processing circuit 100D has the same configuration as the audio signal processing circuit 100C of FIG. 6, except for an output stage. A power amplifier 230D is a class D amplifier capable of receiving a digital audio signal, and the audio signal processing circuit 100D outputs a digital audio signal S₆.

### Fifth Embodiment

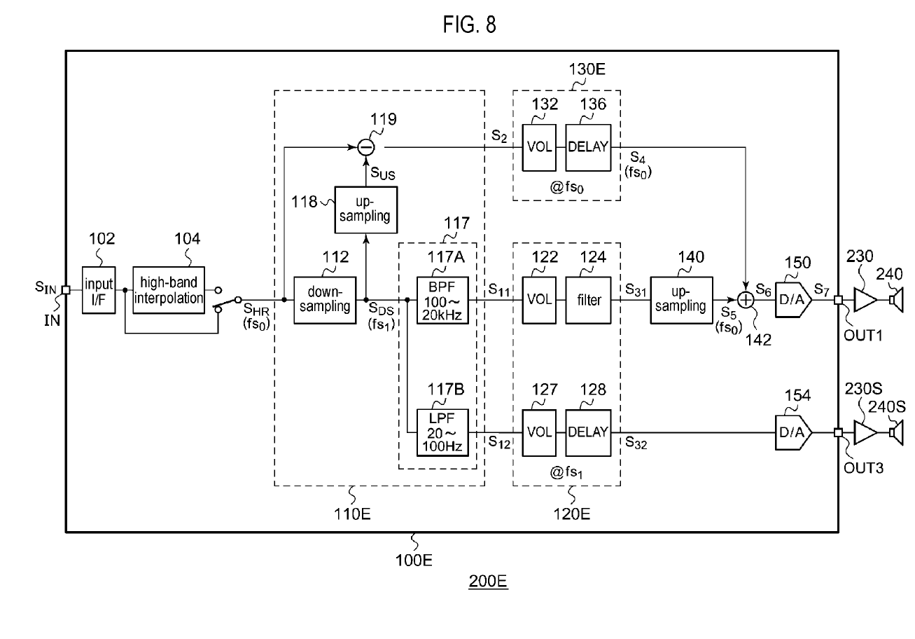

FIG. 8 is a block diagram of an audio system 200E according to a fifth embodiment. An audio signal processing circuit 100E can be grasped as a combination of the audio signal processing circuit 100C of FIG. 6 and the audio signal processing circuit 100B of FIG. 5. A frequency band divider 110E divides the first signal S₁ into a signal S₁₁ including a sub-frequency band of deep-bass and a signal S₁₂ including a sub-frequency band higher than that of the signal S₁. The frequency band divider 110E includes a sub-band divider 117 including a hand-pass filter (or high-pass filter) 117A and a low-pass filter 117B.

The main digital signal processor 120E processes the signals S₁₁ and S₁₂ for each sub-frequency band. A digital volume circuit 127 adjusts the volume of the sub-frequency band of deep-bass. The delay block 128 gives a delay to the sub-frequency band of deep-bass, as necessary. The output S₃₁ on the high frequency side of the main digital signal processor 120 E is supplied to a second up-sampling circuit 140.

The output S₃₂ on the low frequency side of the main digital signal processor 120E is converted into an analog audio signal S_{L2} by a D/A converter 154. A power amplifier 230S drives a speaker unit (sub-woofer) 240S according to the audio signal S_{L2}.

The present disclosure has been described above by way of embodiments. The disclosed embodiments are illustrated only. It should be understood by those skilled in the art that various modifications to combinations of elements or processes may be made and such modifications fall within the scope of the present disclosure. Such modifications will be described below.

### (First Modification)

The D/A converters 150 and 152 in FIG. 4, the D/A converters 150, 152 and 154 in FIG. 5, and the D/A converter 150 in FIG. 6 may be provided outside the audio signal processing circuit. In this case, the output stage of the audio signal processing circuit is provided with an output interface for transmitting a digital audio signal to a D/A converter chip at the subsequent stage.

### (Second Modification)

In FIGS. 4 to 6, the power amplifier 230 may be constituted by a class D amplifier that receives a digital input, and the D/A converters 150, 152 and 154 at the output stage of the audio signal processing circuit may be omitted.

### (Third Modification)

In the third and fourth embodiments, the synthesizing method of the outputs S₃ and S₄ of the main digital signal processor and the sub-digital signal processor is not particularly limited. For example, after converting the audio signals S₃ and S₄ to analog audio signals by two D/A converters, respectively, the two analog audio signals may be synthesized by an analog adder.

### (Fourth Modification)

As a modification of the audio system 200B of FIG. 5, the speaker units 240H, 240L and 240S may be a tweeter responsible for the high band, a mid-range speaker (squawker) responsible for the middle band, and a woofer responsible for the low band, respectively. In this case, a filter is added to a reproduction block of the second sub-frequency band corresponding to the low band, in addition, this reproduction block is provided for each channel individually.

### (Fifth Modification)

A fader volume circuit for adjusting the relative volume of a plurality of channels may be added to the subsequent stage of the D/A converter at the final stage.

### (Sixth Modification)

The audio signal processing circuit may include an A/D converter which receives an external analog audio signal and converts it into an input audio signal S_{HR}.

### (Applications)

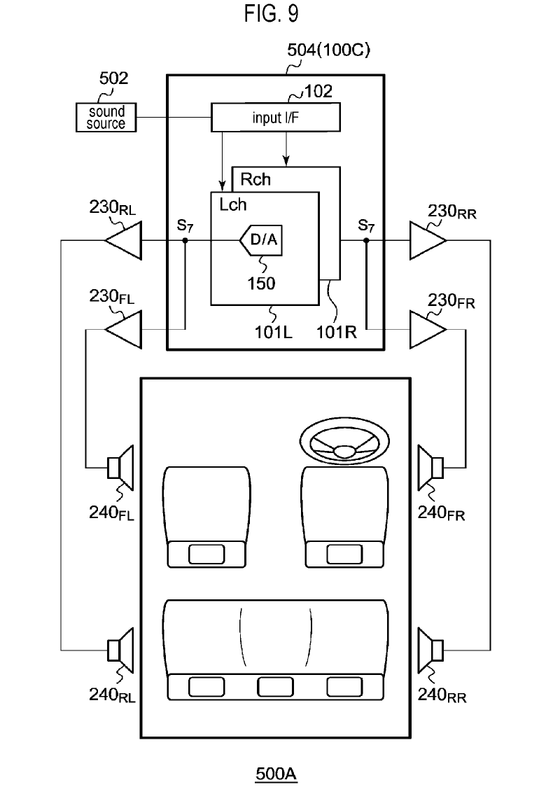

Finally, the applications of the audio signal processing circuit will be explained. FIG. 9 is a block diagram of an in-vehicle audio system including the audio signal processing circuit.

The in-vehicle audio system 500A includes four speakers 240_{FL}, 240_{FR}, 240_{RL} and 240_{RR}.

A sound source 502 outputs digital audio signals of 2 left/right (LR) channels. An audio signal processing circuit 504 includes an input interface 102 for receiving the digital audio signals from the sound source 502, and two circuit blocks 101 L and 101R corresponding to the left and right channels. For example, the audio signal processing circuit 504 can be constructed by using the architecture of the audio signal processing circuit 1000 according to the third embodiment, and each of the circuit blocks 101L and 101R includes the high-band interpolator 104 to the D/A converter 150 in FIG. 6.

An output of the D/A converter 150 of the circuit block 101L is distributed to power amplifiers 230_{FL} and 230_{RL} via a fader volume (not shown). Similarly, the output of the D/A converter 150 of the circuit block 101R is distributed to power amplifiers 230_{FR} and 230_{RR} via a fader volume (not shown). Each of the power amplifiers 230 drives the corresponding speaker 240. Each of the power amplifiers 230 may be a class D amplifier, and the audio signal processing circuit 504 may employ the architecture of the audio signal processing circuit 100D of the fourth embodiment.

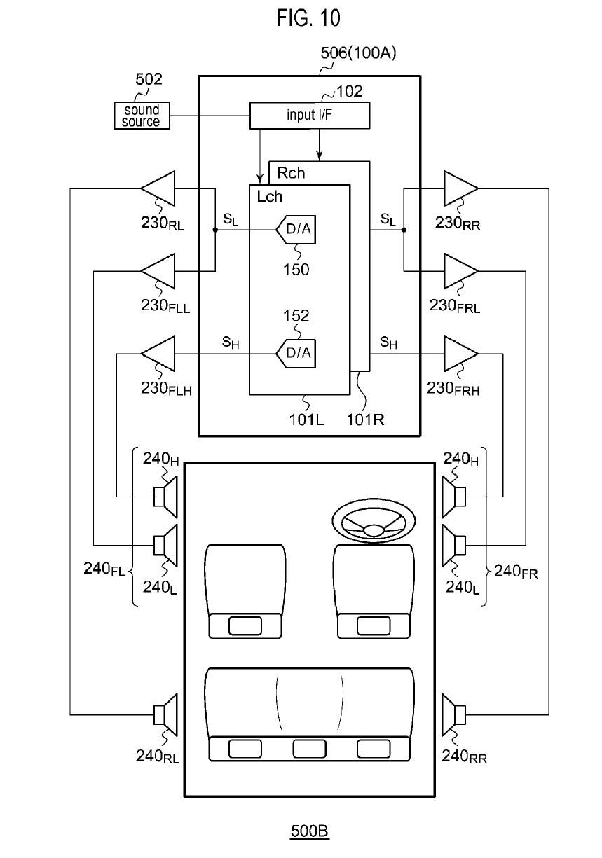

FIG. 10 is a block diagram of another in-vehicle audio system. The in-vehicle audio system 500B includes four speakers 240_{FL}, 240_{FR}, 240_{RL}, and 240_{RR}. The front speakers 240_{FL} and 240_{FR} include a tweeter unit 240_{H} and a woofer unit 240_{L}, respectively.

An audio signal processing circuit 506 includes an input interface 102 for receiving a digital audio signal from a sound source 502, and two circuit blocks 101L and 101R corresponding to 2 left/right channels. For example, the audio signal processing circuit 506 can be constituted by using the architecture of the audio signal processing circuit 100A according to the first embodiment, and each circuit block 101 includes the high-hand interpolator 104 to the D/A converters 150 and 152 in FIG. 4.

The output S_{L} of the DA converter 150 of the left channel circuit block 101L is distributed to power amplifiers 230_{FLL} and 230_{RL} via a fader volume (not shown). The output S_{H} of the D/A converter 152 of the circuit block 101L is supplied to a power amplifier 230_{FLH}. The same applies to the right channel circuit block 101R.

Each power amplifier 230 drives the corresponding speaker (speaker unit) according to the input audio signal.

When the in-vehicle audio system 500 includes a sub-woofer, it is possible to adopt the architecture of the audio signal processing circuit 100B according to the second embodiment or the audio signal processing circuit 100E according to the fifth embodiment as an audio signal processing circuit.

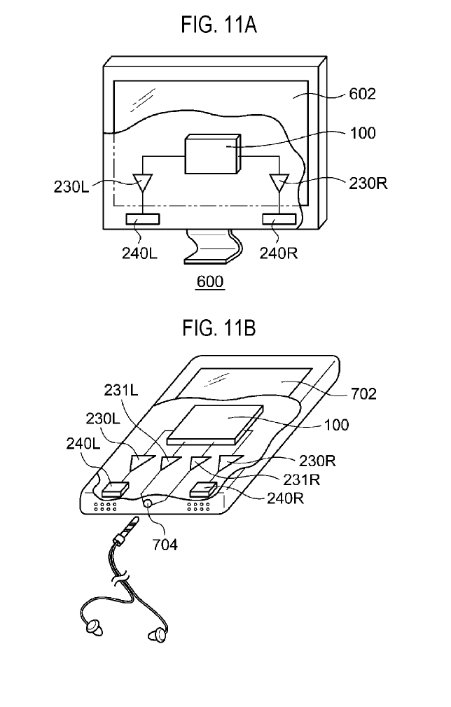

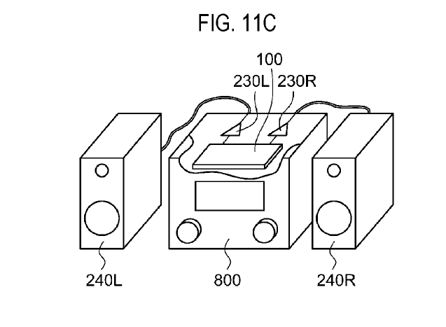

FIGS. 11A and 11B are views showing an electronic apparatus including the audio signal processing circuit 100. The electronic apparatus of FIG. 11A is a display 600. The display 600 includes a display panel 602, an audio signal processing circuit 100, power amplifiers 230L and 230R and speaker units 240L and 240R.

The electronic apparatus 700 of FIG. 11B is a portable apparatus, such as a smart phone, a tablet personal computer (PC), an audio player or the like. The compact information terminal 700 includes a housing 702, a display 702, a headphone terminal 704, power amplifiers 230L, 230R, 231L and 231R and speaker units 240L and 240R. The outputs of the power amplifiers 231L and 231R are connected to a headphone 710 via the headphone terminal 704.

FIG. 11C is a view showing an audio component device 800. The audio component device 800 includes an audio signal processing circuit 100 and power amplifiers 230L and 230R. The power amplifiers 230L and 230R drive speaker units 240L and 240R connected via speaker cables, respectively.

According to the present disclosure in some embodiments, it is possible to provide an audio system capable of reproducing a high-resolution sound source with low cost or low power consumption.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. An audio signal processing circuit comprising:
a frequency band divider configured to divide an input audio signal having an input sampling frequency into a first signal down-sampled to an internal sampling frequency including a first frequency band lower than the input sampling frequency, and a second signal including a second frequency hand higher than the first frequency band; and
a main digital signal processor configured to perform digital signal processing on the first signal.

2. The audio signal processing circuit of claim 1, wherein the frequency band divider includes a down-sampling circuit that down-samples the input audio signal to the internal sampling frequency, and
wherein an output of the down-sampling circuit is the first signal.

3. The audio signal processing circuit of claim 2, wherein the frequency band divider further includes a filter disposed at the subsequent stage of the down-sampling circuit and an output of the filter is the first signal.

4. The audio signal processing circuit of claim 2, wherein the frequency band divider further includes:
a first up-sampling circuit that up-samples the output of the down-sampling circuit to the input sampling frequency; and
a subtractor that generates a difference between the input audio signal and an output of the first up-sampling circuit, and
wherein an output of the subtractor is the second signal.

5. The audio signal processing circuit of claim 1, wherein the frequency band divider further includes a high-pass filter that passes a high frequency component of the input audio signal,
wherein an output of the high-pass filter is the second signal.

6. The audio signal processing circuit of claim 1, further comprising a sub-digital signal processor configured to perform digital signal processing on the second signal,
wherein the sub-digital signal processor performs digital processing using fewer steps compared to the main digital signal processor.

7. The audio signal processing circuit of claim 1, wherein the frequency band divider further includes a sub-band divider configured to divide the first signal into a plurality of sub-frequency bands,
wherein the main digital signal processor executes digital signal processing for each of the sub-frequency bands.

8. The audio signal processing circuit of claim 1, wherein the second signal includes a portion of an audible frequency band.

9. The audio signal processing circuit of claim 1, wherein the first signal and the second signal e individually output.

10. The audio signal processing circuit of claim 1, wherein an audible frequency band is not included in the second signal, and
wherein a signal obtained by combining the first signal and the second signal is output.

11. The audio signal processing circuit of claim 8, further comprising:
a second up-sampling circuit configured to up-sample an output of the main digital signal processor to the input sampling frequency; and
an adder configured to combine the second signal and an output of the second up-sampling circuit,
wherein a signal obtained by recombining the first signal and the second signal is output.

12. An audio signal processing circuit comprising:
a down-sampling circuit configured to down-sample an input audio signal having an input sampling frequency to an internal sampling frequency lower than the input sampling frequency;
an up-sampling circuit configured to up-sample an output of the down-sampling circuit to the input sampling frequency; and
a subtractor configured to generate a difference between the input audio signal and an output of the up-sampling circuit.

13. The audio signal processing circuit of claim 1, wherein the input sampling frequency is 96 kHz or 192 kHz, and the internal sampling frequency is 48 kHz.

14. The audio signal processing circuit of claim 1, wherein the audio signal processing circuit is integrally integrated on a single semiconductor substrate.

15. An in-vehicle audio system comprising the audio signal processing circuit of claim 1.

16. An audio component device comprising the audio signal processing circuit of claim 1.

17. An electronic apparatus comprising the audio signal processing circuit of claim 1.

18. A method of processing an audio signal, comprising:
dividing an input audio signal into a first signal including a first frequency band and being down-sampled from the input audio signal and a second signal including a second frequency band higher than the first frequency band; and
performing digital signal processing on the first frequency band.
